(19) United States
(12) Patent Application Publication
(10) Pub. No.: US 2026/0364444 A1
(43) Pub. Date: Nov. 19, 2026

(54) GAMING CONTROLLER

(71) Applicant: BeSpoke Instruments LLC, Rochester, MI (US)

(72) Inventors: Nathaniel Beutler, Rochester, MI (US); Tyler Beutler, Rochester, MI (US)

(73) Assignee: BeSpoke Instruments LLC, Rochester, MI (US)

(21) Appl. No.: 19/210,225

(22) Filed: May 16, 2025

(51) Int. Cl. A63F 13/24; A63F 13/211

(52) U.S. Cl. CPC A63F 13/24; A63F 13/211

(57) ABSTRACT

A controller that communicates signals to a computing device includes an upper portion, a sensor, a lower portion and a connecting portion. The upper portion includes a palm engaging portion. The sensor is disposed in the upper portion and senses an articulation and a speed of the articulation of the palm engaging portion. The lower portion includes a central base support housing having a finger engaging portion. The connecting portion includes a plurality of post assemblies that extend between the upper portion and the lower portion. Each post assembly includes a post, and a biasing member. The post has a first portion that nests in a pocket defined in the upper portion, the first portion rotatably mounted relative to an axle supported by the upper portion; and a second portion including a post pedestal having a boss. The sensor senses the articulation and the speed of the palm engaging portion.

### CROSS REFERENCE TO RELATED APPLICATION

The application claims priority to U.S. Patent Application No. 63/648,849 filed May 17, 2024. The entire disclosure of the above application is incorporated herein by reference.

### FIELD

The present application generally relates to a computer controller and more particularly to a gaming controller that incorporates an articulating palm engaging portion, a forward finger engaging button array and a thumb control key assembly and directional pad, the gaming controller translating motion of a users' palm into a motion input to a computer.

### BACKGROUND

Computer controllers, such as gaming controllers, are available in many implementations for translating inputs to a computer that is running the selected game. In some examples, such as when controlling movement of a game player on the computer screen, a user provides inputs to a keyboard indicative of a direction the user wants the game player to move. In some implementations, the “WASD” keys can correspond to a forward, left, backward and right movement command, respectively. Concurrently, a user can interface with a mouse to provide additional commands. Many times it is awkward, fatiguing, and inefficient using a first hand to press keys on a keyboard to provide motion inputs while using the other hand to provide mouse inputs. Accordingly, while such gaming controller solutions work well for their intended purpose, there exists an opportunity for improvement in the relevant art.

### SUMMARY

According to one example aspect of the present disclosure, a controller that communicates signals to a computing device includes an upper portion, a sensor, a lower portion and a connecting portion. The upper portion includes a palm engaging portion. The sensor is disposed in the upper portion and senses an articulation and a speed of the articulation of the palm engaging portion. The lower portion includes a central base support housing having a finger engaging portion. The connecting portion includes a plurality of post assemblies that extend between the upper portion and the lower portion. Each post assembly includes a post, a biasing member. The post has (i) a first portion that nests in a pocket defined in the upper portion, the first portion rotatably mounted relative to an axle supported by the upper portion, and (ii) a second portion including a post pedestal having a boss that translates relative to a lower bore defined in the lower portion. The biasing member biases the post toward the upper portion, wherein the upper portion articulates around the axle during tilting of the palm engaging portion relative to the lower portion. The sensor senses the articulation and the speed of the palm engaging portion and communicates a signal to the computing device indicative of the articulation and speed.

In addition to the foregoing, the palm engaging portion includes a flat top surface and a rounded annular outer surface.

In addition to the foregoing, the palm engaging portion is formed of metal material.

In addition to the foregoing, the controller further comprises a radial bearing mounted between the axle and the post on each of the post assemblies.

In addition to the foregoing, each post assembly further comprises a linear bearing disposed in the lower portion, wherein the respective bosses translate relative to the linear bearings during the tilting of the palm engaging portion.

In other features, each post assembly further comprises a bushing cap received in the lower portion, wherein the bushing cap defines a lip that captures a collar extending from a respective post pedestal.

In additional features, the lower portion defines an upper bore that receives the bushing cap, a biasing surface defined by an intermediate bore, and a lower bore that receives the linear bearing, wherein the biasing member biases against the biasing surface to bias the collar of the post pedestal into the lip of the bushing cap.

In other examples, the finger engaging portion includes a plurality of buttons thereon.

In other examples, the finger engaging portion is formed on a forward finger housing of the lower portion, wherein the forward finger housing presents the plurality of buttons on the finger engaging portion at an angle relative to a flat top surface of the palm engaging portion.

In additional features, the plurality of buttons are arranged at an angle between 45 and 80 degrees relative to a bottom surface of the central base support housing.

In other features, the plurality of buttons comprises four buttons.

In addition to the foregoing, the controller further includes a peripheral portion having a directional pad.

In other features, the peripheral portion further comprises a key assembly thereon, wherein keys disposed on the key assembly are configured to be selectively programmed for assignment to predetermined tasks.

In other features, depression of a key of the key assembly corresponds to changing of assignments of the four buttons.

In additional features, the sensor comprises at least one of a gyrometer and an accelerometer.

In other features, the sensor comprises at least one of a tilt sensor and an accelerometer.

In additional examples, the post assemblies comprises eight post assemblies extending between the upper portion and the lower portion. It is appreciated however that other quantities of post assemblies may be used within the scope of the disclosure such as, but not limited to, four to ten post assemblies.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a top perspective view of a gaming controller in accordance with a first example of the present disclosure;

FIG. 2 is a front view of the gaming controller of FIG. 1 according to principles of the present application;

FIG. 3 is a rear view of the gaming controller of FIG. 1 according to principles of the present application;

FIG. 4 is a first side view of the gaming controller of FIG. 1 according to principles of the present application;

FIG. 5 is a second side view of the gaming controller of FIG. 1 according to principles of the present application;

FIG. 6 is a top view of the gaming controller of FIG. 1 according to principles of the present application;

FIG. 7 is a bottom view of the gaming controller of FIG. 1 according to principles of the present application;

FIG. 8 is a front perspective exploded view of the gaming controller of FIG. 1 according to principles of the present application;

FIG. 9 is a sectional view of the gaming controller of FIG. 1 and shown in an at rest position with no user input according to principles of the present application;

FIG. 10 is a sectional view of the gaming controller of FIG. 1 and shown with the palm engaging portion tilted in a rearward direction from user input according to principles of the present application; and

FIG. 11 is a sectional view of the gaming controller of FIG. 1 and shown with the palm engaging portion tilted in a forward direction from user input according to principles of the present application.

### DESCRIPTION

As identified above, computer controllers, such as gaming controllers, are available in many implementations for translating user inputs to a computer that is running the selected game. In some examples, such as when controlling movement of a game player on a video display screen, a user provides inputs to a keyboard indicative of a direction the user wants the game player to move. In some implementations, the “WASD” keys can correspond to a forward, left, backward and right movement command, respectively. Concurrently, a user can interface with a mouse to provide additional commands. Many times it is awkward and inefficient using a first hand to press keys on a keyboard to provide motion inputs while using the other hand to provide mouse inputs.

The present disclosure provides a computer controller (e.g., a gaming controller) that incorporates an articulating palm engaging portion, a forward finger engaging button array and a thumb control key assembly and directional pad, the gaming controller translates motion of a users' palm into a motion input to a computer (such as for controlling movement of a gaming character). The articulating palm engaging portion articulates based on input from a users' palm, the articulating direction and speed of the articulation corresponding to an input signal sent to the computer. The forward finger engaging button array can include programmable buttons that are selectively assigned to correlate with desired task inputs. The thumb control key assembly and directional pad provides a directional control function and a button assembly for selective programming of the controller.

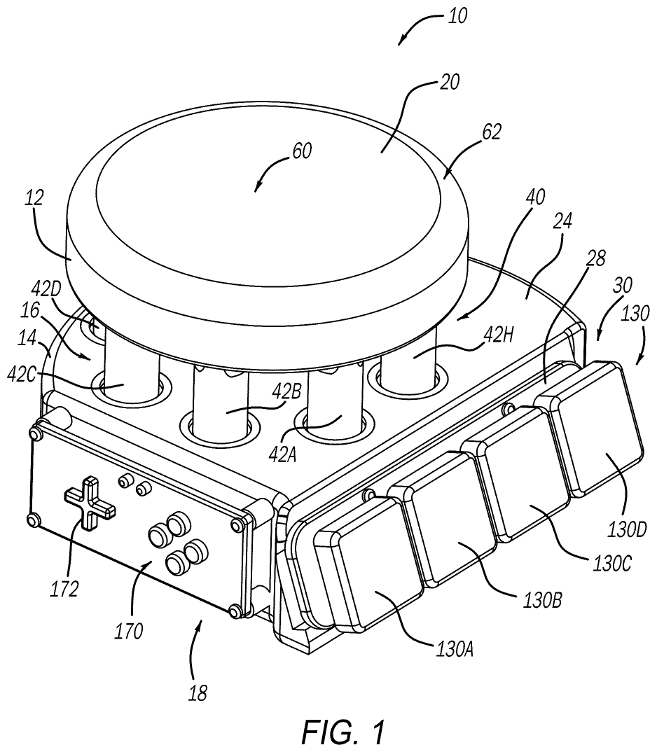

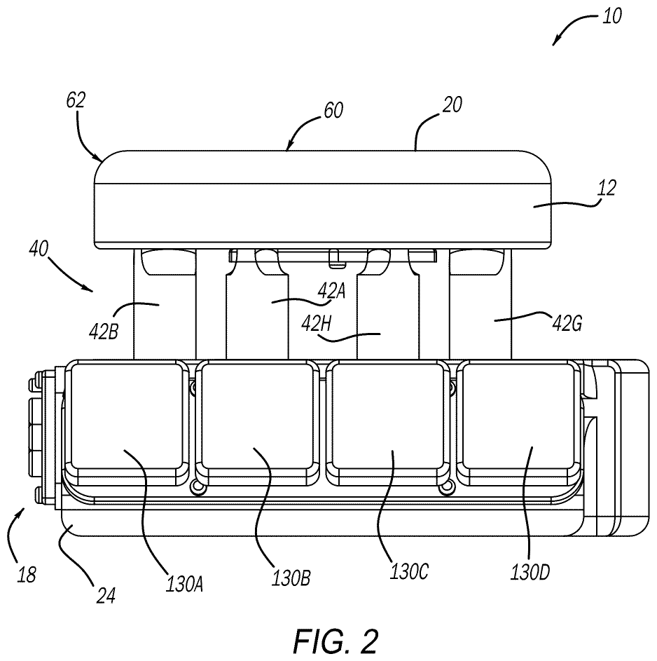

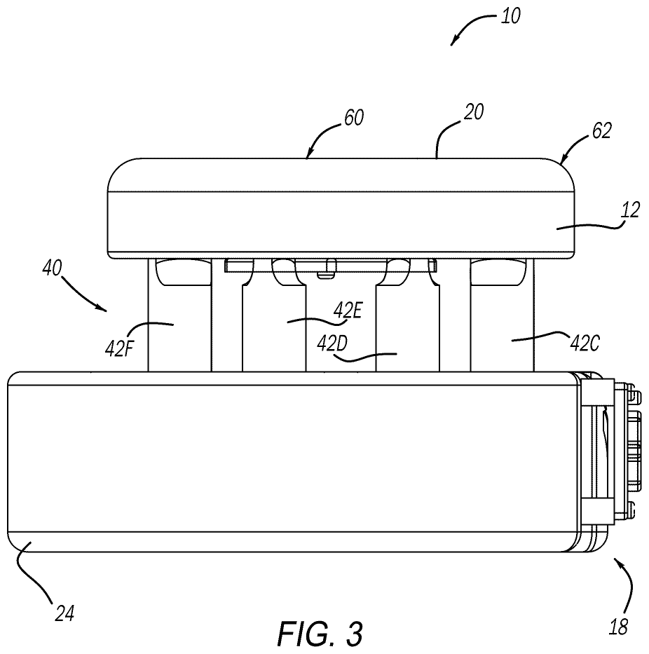

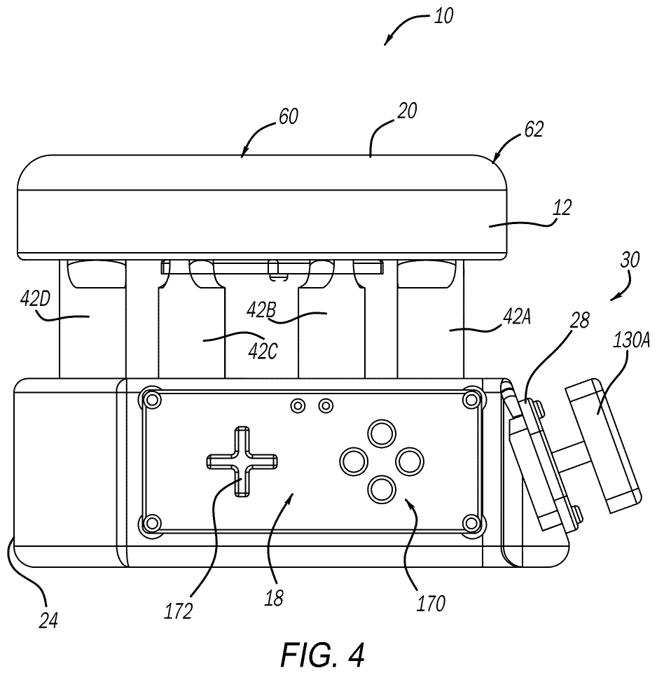

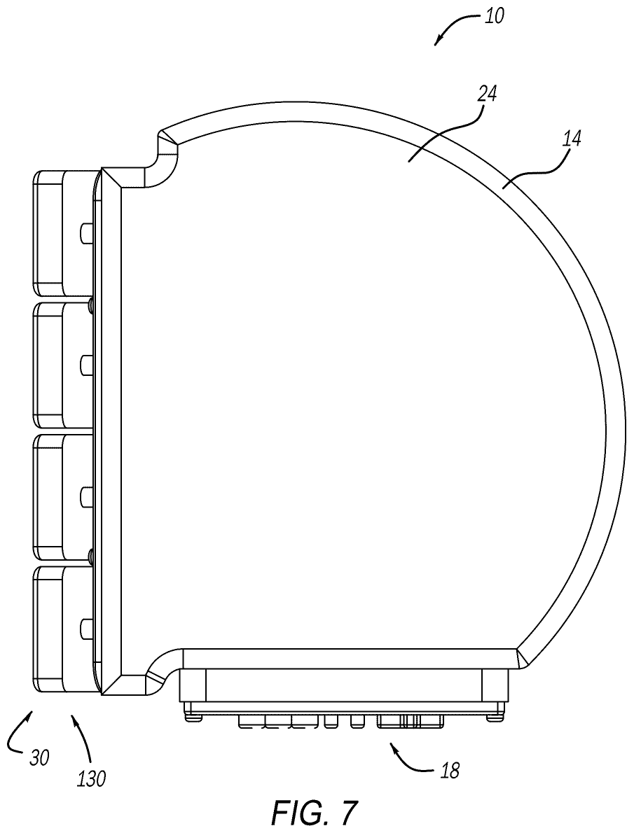

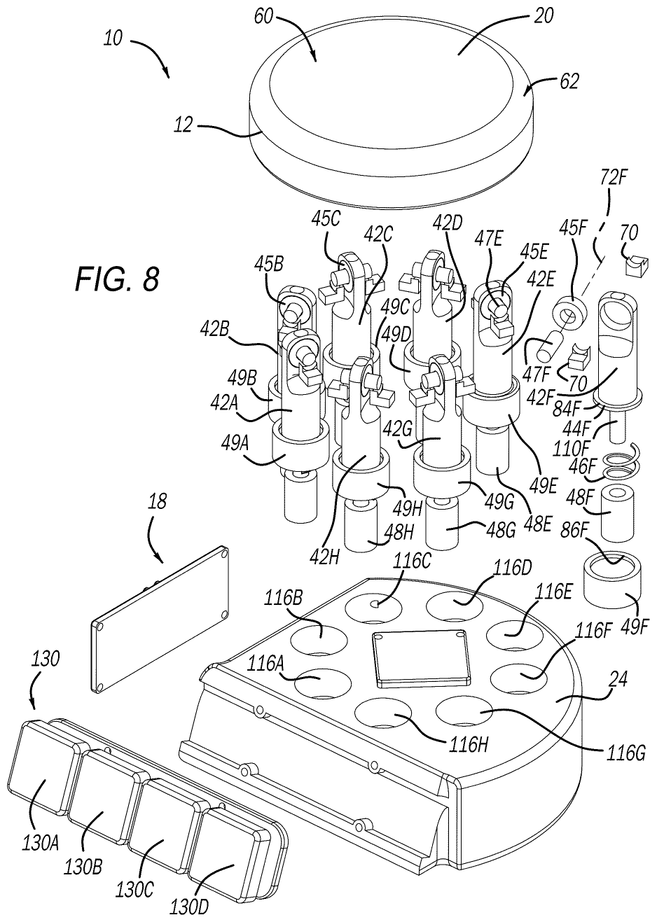

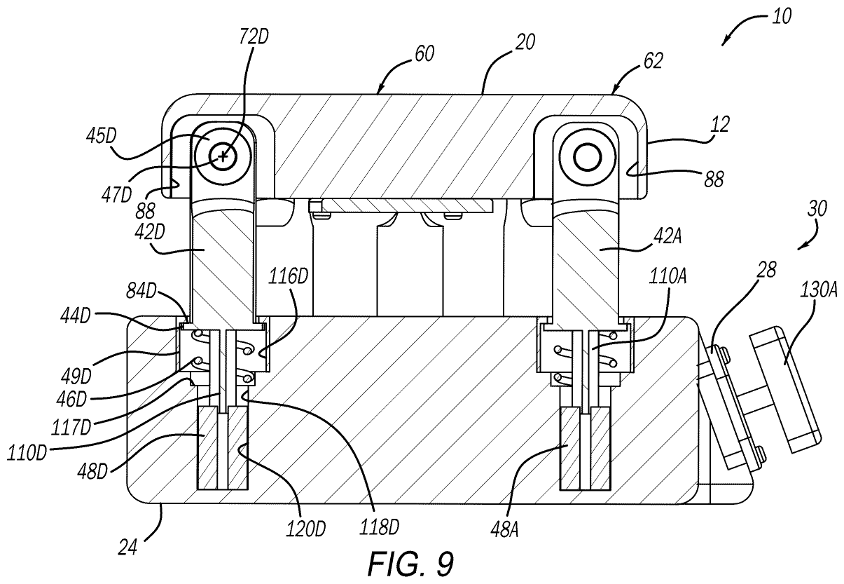

With initial reference to FIGS. 1-8, a gaming controller constructed in accordance to examples of the present disclosure is shown and generally identified at reference numeral 10. The gaming controller 10 generally includes an upper portion 12, a lower portion 14, a connecting portion 16 and a peripheral portion 18. The upper portion 12 generally includes a palm engaging portion 20. The lower portion 14 generally includes a central base support housing 24. The central base support housing 24 includes a forward finger housing 28 that provides a finger engaging portion 30. The connecting portion 16 connects the upper portion 12 and the lower portion 14. The connecting portion 16 generally comprises a series of post assemblies, collectively identified at reference 40. As will be described herein, the post assemblies 40 allow the palm engaging portion to articulate relative to the central base support housing 24 (see FIGS. 9-11). The post assemblies 40 in the exemplary embodiment include eight post assemblies 40 however other quantities are contemplated. As best shown in FIG. 8, the post assemblies 40 comprise posts 42A-42H having post pedestals 44A-44H, upper rotational bearings 45A-45H, biasing members 46A-46H, upper bearing axles 47A-47H, linear bearings 48A-48H, and bushing caps 49A-49H.

With continued reference to FIGS. 1-7 and particular reference to FIG. 8, the palm engaging portion 20 will be further described. The palm engaging portion 20 includes a generally flat top surface 60 and a rounded annular outer surface 62. The flat top surface 60 provides a positive locating surface for a users' palm while the rounded annular outer surface 62 provides a comfortable engaging surface for the user to positively interact with the palm engaging portion 20. In this regard, the generally round shape of the palm engaging portion 20 specifically provides a structure that invites simple grasping and interaction without needing to look at the controller 10. In examples, the palm engaging portion 20 can be constructed of metal material.

With additional reference now to FIGS. 9-11, additional features of the gaming controller 10 will be described. The palm engaging portion 20 defines a plurality of inset portions or pockets 88 configured to accept portions of the posts 42A-42H. In particular, the pockets 88 capture bearing axle supports 70 (FIG. 8) that support the respective axles 47A-47H and bearings 45A-45H. The bearings 45A-45H facilitate smooth rotation of the palm engaging portion 20 about respective axle axes 72A-72H defined along the axles 47A-47H relative to the posts 40 (see FIGS. 9-11).

The post pedestals 44A-44H can each have respective bosses 110A-110H that axially slide relative to the respective linear bearings 48A-48H. The post pedestals 44A-44H further define respective collars 84A-84H that are captured by respective lips 86A-86H (FIG. 8) inwardly extending from the bushing caps 49A-49H. The bushing caps 49A-49H are received in upper bores 116A-116H in the central base support housing 24. The biasing members 46A-46H bias against respective biasing surfaces 117A-117H defined at intermediate bores 118A-118H in the central base support housing 24. The linear bearings 48A-48H are received in lower bores 120A-120H in the central base support housing 24.

During articulation of the palm engaging portion 20, a user's palm can tilt the palm engaging portion 20 in any direction causing the corresponding posts 40 to at least partially translate downwardly into the bias of the respective biasing members 46A-46H. Meanwhile, the post pedestals 44A-44H can each have respective bosses 110A-110H that axially slide relative to the respective linear bearings 48A-48H providing a smooth movement of the palm engaging portion 20. In addition, the bearings 45A-45H facilitate smooth rotation of the palm engaging portion 20 about the respective axle axes 72A-72H defined along the axles 47A-47H relative to the posts 40. In examples, the gyrometer and accelerometer have analog inputs for variability. Without user input onto the palm engaging portion 20, the biasing members 46A-46H return the palm engaging portion 20 back to an at rest position (FIG. 9). The palm engaging portion 20 can articulate in any direction with respect to the central base support housing 24 with facilitation by the post assemblies 40. It is contemplated that the palm engaging portion 20 can articulate in radial positions attaining fifteen degrees relative to the flat top surface 60. Other degrees are contemplated.

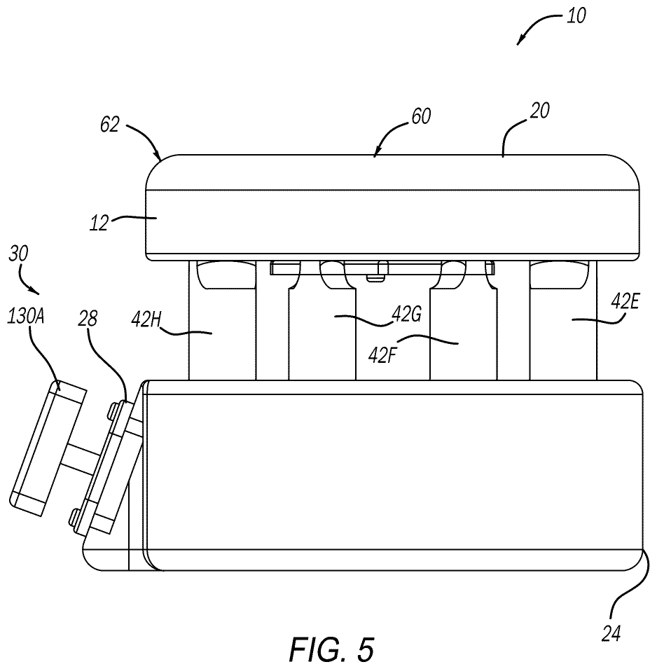

With reference to all FIGS. 1-11, the finger engaging portion 30 will be further described. The finger engaging portion 30 includes a plurality of buttons collectively identified at 130, and individually identified at 130A-130D. While four buttons are shown, other arrangements are contemplated. The forward finger housing 28 generally presents the finger engaging portion 30 at an angle relative to the flat top surface 60 of the palm engaging portion 20 to orient the buttons 130 for ease of engagement with a users' fingers. By way of example, the buttons 130 can be arranged at an angle 132 (FIG. 5) relative to a bottom surface 134 of the central base support housing 24. By way of example only, the angle 132 can be between 10 and 80 degrees.

Four buttons 130A-130D are provided in the example shown corresponding for interaction with a users' four fingers. The buttons 130 can be assigned tasks by the user. The buttons 130 can be biased outwardly to an at-rest position. Depression of the buttons 130 can cause a signal to be communicated by the controller 10 to the computer.

The peripheral portion 18 generally includes a thumb control key assembly 170 and directional pad 172. The thumb control key assembly 170 provides a plurality of keys or buttons for selective inputs and/or programming of the controller 10. The directional pad 172 provides a directional control input function. The thumb control key assembly 170 includes a plurality of keys or buttons, such as four in the example shown. The thumb control key assembly 170 can be used to program specific functionality of the controller 10. By way of example only, buttons 130A-130D are initially assigned as inputs 1-4. By actuating a first key on the thumb control key assembly 170, the buttons 130A-130D can be assigned to different inputs such as 5-8. As can be appreciated, by actuating a second key on the thumb control key assembly 170, the buttons 130A-130D can be assigned to yet different inputs 9-12. The assignment can continue according to the pressing of other keys on the thumb control key assembly 170. In other arrangements, some of the keys can alternatively be assigned different unique tasks other than switching assignments for the buttons 130A-130D. By way of example, key 3 could be assigned a gesture (e.g. “crouch”), whereby pressing key 3 with a thumb sends a signal indicative of wanting the controlled gaming character to crouch. The peripheral portion 18 can be programmable in any fashion by the user to suit their interactive (e.g., gaming etc.) needs.

The configuration of the peripheral 18 provides many advantages such as the ability to keep the users' fingers (pointer, middle, ring and pinky) on the buttons 130A-130D while making the assignment adjustments with their thumb on the thumb control key assembly 170. Fatigue is reduced and ergonomics are improved. It is appreciated that the layout and orientation of the directional pad 172 and thumb control key assembly 170 is merely exemplary and it may have other amounts of keys and orientations within the scope of this disclosure.

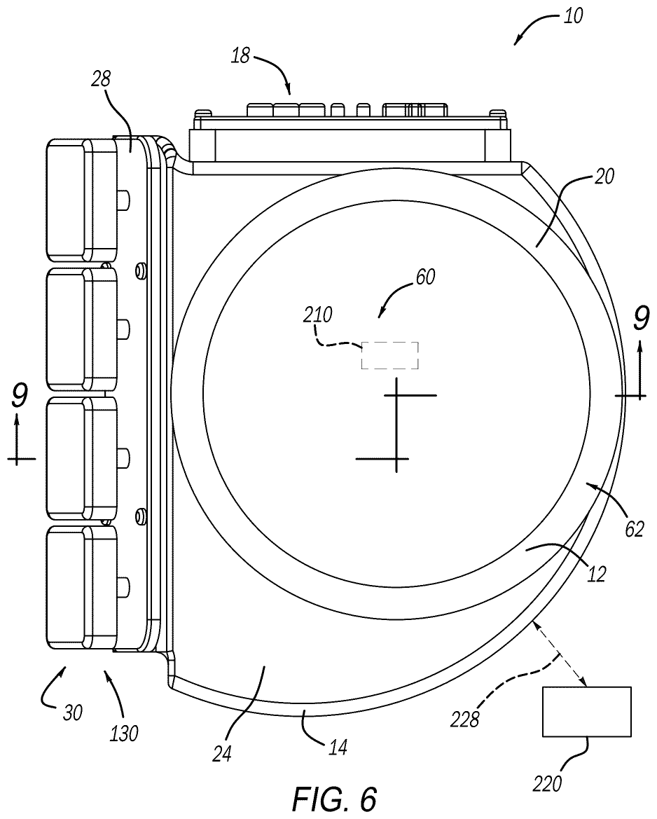

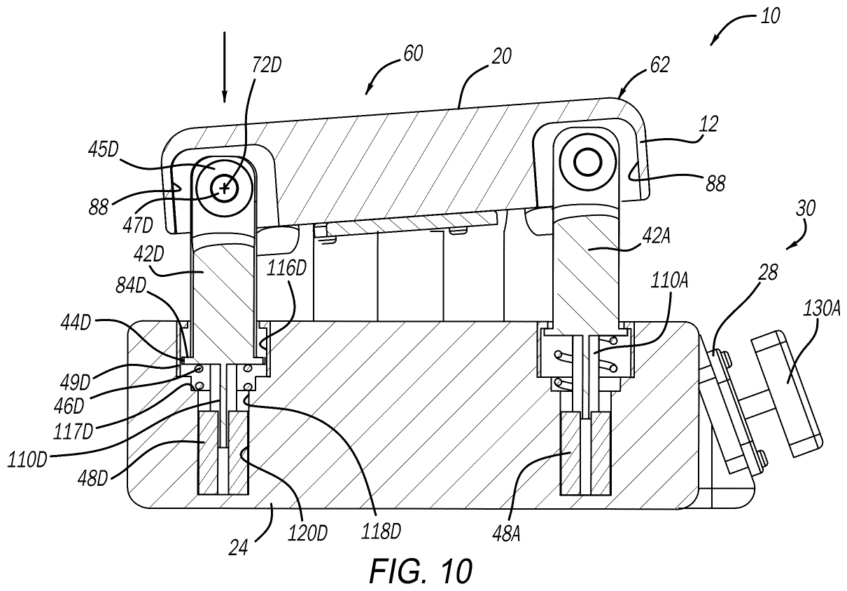

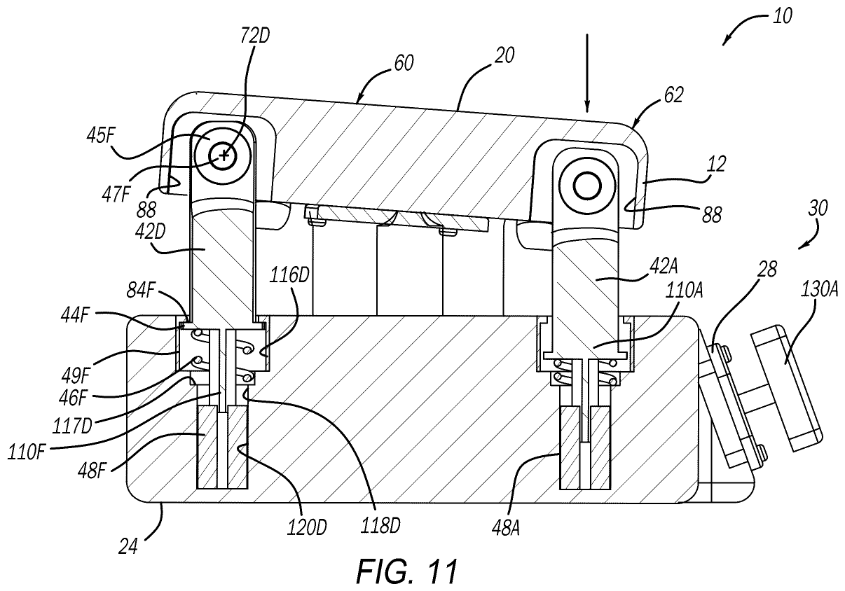

With particular reference to FIG. 6, additional features of the controller 10 will be described. The controller 10 includes a sensor 210 that senses movement and speed of movement of the palm engaging portion 20 and sends a signal to a computing device such as a computer 220 indicative of a position of the palm engaging portion 20. The sensor 210 can be housed in the palm engaging portion 20. In this regard, the sensor 210 can communicate a signal that corresponds to any movements of the palm engaging portion 20 (such as for example the rearward tilted position in FIG. 10, the forward tilted position in FIG. 11 and any position that the palm engaging portion 20 has moved with respect to the posts 40). The sensor 210 can be any sensor that senses movement and speed such as, but not limited to, any combinations of a gyrometer, accelerometer, light sensor, laser sensor, infrared sensor, flex sensor, force sensor, distance sensor, proximity sensor, hall effect sensor, magnetometer, joystick, motion sensor, vision sensor/camera, muscle sensor, strain gauge, potentiometer, and a tilt sensor.

It is contemplated that the controller 10 can communicate with the computer 220 by a wired connection or a wireless connection 228. In the example shown, the sensor 210 senses the angle of the palm engaging portion 20 or, for example, an angle the flat top portion 60 makes relative to the bottom surface 134 of the central base support housing 24. In addition, the sensor 210 senses the speed that the palm engaging portion 20 has accelerated to the tilted position. In other words, the sensor 210 determines how fast the tilted input has occurred. As can be appreciated, if the speed at which the palm engaging portion 20 has been tilted is fast, the input communicated to the computer 220 is indicative of the fast speed for correlating a fast movement of the gaming activity. In sum, the sensor 210 reads the angle and the speed at which the angle has been achieved. This will correlate to an input for movement of a target on a computer screen.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present disclosure, its application or uses. Thus, variations that do not depart from the gist of the present disclosure are intended to be within the scope of the present disclosure.

What is claimed is:

1. A controller that communicates signals to a computing device, the controller comprising:
an upper portion including a palm engaging portion;
a sensor disposed in the upper portion that senses an articulation and a speed of the articulation of the palm engaging portion;
a lower portion including a central base support housing having a finger engaging portion; and
a connecting portion including a plurality of post assemblies that extend between the upper portion and the lower portion, wherein each post assembly of the post assemblies comprise:
a post having (i) a first portion that nests in a pocket defined in the upper portion, the first portion rotatably mounted relative to an axle supported by the upper portion, and (ii) a second portion including a post pedestal having a boss that translates relative to a lower bore defined in the lower portion;
a biasing member that biases the post toward the upper portion, wherein the upper portion articulates around the axle during tilting of the palm engaging portion relative to the lower portion; and
wherein the sensor senses the articulation and the speed of the palm engaging portion and communicates a signal to the computing device indicative of the articulation and speed.

2. The controller of claim 1, wherein the palm engaging portion includes a flat top surface and a rounded annular outer surface.

3. The controller of claim 2, wherein the palm engaging portion is formed of metal material.

4. The controller of claim 1, further comprising a radial bearing mounted between the axle and the post on each of the post assemblies.

5. The controller of claim 4, wherein each post assembly further comprises a linear bearing disposed in the lower portion, wherein the respective bosses translate relative to the linear bearings during the tilting of the palm engaging portion.

6. The controller of claim 5, wherein each post assembly further comprises a bushing cap received in the lower portion, wherein the bushing cap defines a lip that captures a collar extending from a respective post pedestal.

7. The controller of claim 6, wherein the lower portion defines an upper bore that receives the bushing cap, a biasing surface defined by an intermediate bore, and wherein the lower bore receives the linear bearing, wherein the biasing member biases against the biasing surface to bias the collar of the post pedestal into the lip of the bushing cap.

8. The controller of claim 1, wherein the finger engaging portion includes a plurality of buttons thereon.

9. The controller of claim 8, wherein the finger engaging portion is formed on a forward finger housing of the lower portion, wherein the forward finger housing presents the plurality of buttons on the finger engaging portion at an angle relative to a flat top surface of the palm engaging portion.

10. The controller of claim 9, wherein the plurality of buttons are arranged at an angle between 45 and 80 degrees relative to a bottom surface of the central base support housing.

11. The controller of claim 10, wherein the plurality of buttons comprises four buttons.

12. The controller of claim 11, further comprising a peripheral portion having a directional pad.

13. The controller of claim 12, wherein the peripheral portion further comprises a key assembly thereon, wherein keys disposed on the key assembly are configured to be selectively programmed for assignment to predetermined tasks.

14. The controller of claim 13, wherein depression of a key of the key assembly corresponds to changing of assignments of the four buttons.

15. The controller of claim 1, wherein the sensor comprises at least one of a gyrometer and an accelerometer.

16. The controller of claim 1, wherein the sensor comprises at least one of a tilt sensor and an accelerometer.

17. The controller of claim 1, wherein the post assemblies comprises eight post assemblies extending between the upper portion and the lower portion.
